(19) United States
(12) Patent Application Publication
(10) Pub. No.: US 2026/0356419 A1
(43) Pub. Date: Nov. 12, 2026

(54) PRE-LOADED STEERING ANTI-ROTATION DEVICE

(71) Applicant: Schaeffler Technologies AG & Co. KG, Herzogenaurach (DE)

(72) Inventors: Renato de Paula, Sterling Heights, MI (US); Alexandre Camilo, Rochester HIlls, MI (US)

(21) Appl. No.: 19/201,195

(22) Filed: May 7, 2025

(51) Int. Cl. B62D 5/00; B62D 3/06; F16H 25/20; F16H 25/24

(52) U.S. Cl. CPC B62D 5/001; B62D 3/06; F16H 25/2454; F16H 2025/204

(57) ABSTRACT

An anti-rotation device may include an outer housing defining an interior cavity and one or more exterior holes. The anti-rotation device may include a plunger coupled to the outer housing. The anti-rotation device may include a yoke in contact with the plunger configured to be compressed by the plunger. The anti-rotation device may include one or more pads configured to extend outwards through the one or more exterior holes of the outer housing due to the compression of the plunger.

### TECHNICAL FIELD

The present disclosure generally relates to vehicle steering gears, and, more particularly, to steering gears in autonomous vehicles.

### BACKGROUND

As autonomous driving continues to improve and fully autonomous driving emerges, design features that may have been needed for human interaction and/or input may no longer be needed. This may include features in electric power steering (EPS) type steering gears, where input from the driver becoming obsolete may lead to components (e.g., components of the rack and pinion) of the EPS steering gears becoming obsolete as well. Removing unnecessary design aspects in the EPS steering gears, may result in reduced tooling and production costs.

### SUMMARY

An anti-rotation device is disclosed, in accordance with one or more embodiments of the present disclosure. The anti-rotation device may include an outer housing defining an interior cavity and one or more exterior holes. The anti-rotation device may include a plunger coupled to the outer housing. The anti-rotation device may include a yoke in contact with the plunger and configured to be compressed by the plunger. The anti-rotation device may include one or more pads configured to extend outwards through the one or more exterior holes of the outer housing due to the compression of the plunger.

In some aspects, the plunger is coupled to the outer housing by threads on the plunger and the outer housing.

In some aspects, the one or more pads are made of treated steel.

In some aspects, the one or more pads are made of one of nylon, plastic, or reinforced plastic.

In some aspects, the one or more pads are coupled to each other by a rim.

In some aspects, the rim coupling the one or more pads is configured to allow contact between the plunger and the yoke.

In some aspects, the plunger and the yoke contact each other through the rim by a pair of opposing protrusions, with one protrusion located on the plunger and another protrusion located on the yoke.

In some aspects, the anti-rotation device further comprises one or more springs disposed between the plunger and the one or more pads, wherein the one or more springs are in contact with the plunger, wherein the one or more springs are configured to be compressed by the plunger to cause the one or more pads to extend outwards.

In some aspects, the one or more springs are configured as one of: a rubber ring, a compression spring, a wave spring, or a disk spring.

In some aspects, the rim and the one or more springs have an equal diameter.

In some aspects, the one or more exterior holes defined by the outer housing includes two exterior holes located opposite each other.

In some aspects, the plunger includes one or more recesses to facilitate coupling with the outer housing.

A spindle assembly is disclosed, in accordance with one or more embodiments of the present disclosure. The spindle assembly may include a spindle. The spindle assembly may include an anti-rotation device. The anti-rotation device may include an outer housing defining an interior cavity larger than a major diameter of the spindle and one or more exterior holes and configured to surround at least a coupling area of the spindle. The anti-rotation device may include a plunger coupled to the outer housing. The anti-rotation device may include a yoke in contact with the plunger and configured to be compressed by the plunger in order to make contact with the spindle and further cause the spindle to contact the outer housing opposite the yoke. The anti-rotation device may include one or more pads configured to extend outwards through the one or more exterior holes of the outer housing due to the compression of the plunger.

In some aspects, the interior cavity of the outer housing has a shape configured to match a contour of the coupling area of the spindle.

In some aspects, the yoke has a shape configured to match a contour of the coupling area of the spindle.

In some aspects, the coupling area of the spindle surrounded has a hexagon-shaped contour.

In some aspects, the coupling area of the spindle is located between threaded areas of the spindle.

A drive system is disclosed, in accordance with one or more embodiments of the present disclosure. The drive system may include a spindle. The drive system may include a housing. The drive system may include one or more rods. The drive system may include an anti-rotation device. The anti-rotation device may include an outer housing defining an interior cavity larger than a major diameter of the spindle and one or more exterior holes and configured to surround at least a coupling area of the spindle. The anti-rotation device may include a plunger coupled to the outer housing. The anti-rotation device may include a yoke in contact with the plunger and configured to be compressed by the plunger in order to make contact with the spindle and further cause the spindle to contact the outer housing opposite the yoke. The anti-rotation device may include one or more pads configured to extend outwards through the one or more exterior holes of the outer housing due to the compression of the plunger and apply a force on the housing in order to prevent rotation of the spindle relative to the housing.

In some aspects, the anti-rotation device forms a prismatic joint with the housing.

In some aspects, the drive system further includes an electric motor, wherein the spindle is connected to the electric motor.

### BRIEF DESCRIPTION OF THE DRAWINGS

The numerous advantages of the disclosure may be better understood by those skilled in the art by reference to the accompanying figures.

FIG. 1A depicts a front cross-sectional view of an anti-rotation device, in accordance with one or more embodiments of the present disclosure.

FIG. 1B depicts a front view of the anti-rotation device, in accordance with one or more embodiments of the present disclosure.

FIG. 1C depicts an exploded view of the anti-rotation device, in accordance with one or more embodiments of the present disclosure.

FIG. 2A depicts a perspective view of a spindle assembly with the anti-rotation device, in accordance with one or more embodiments of the present disclosure.

FIG. 2B depicts a top view of the spindle assembly, in accordance with one or more embodiments of the present disclosure.

FIG. 2C depicts a side view of the spindle assembly, in accordance with one or more embodiments of the present disclosure.

FIG. 2D depicts a front cross-sectional view of the spindle assembly, in accordance with one or more embodiments of the present disclosure.

FIG. 2E depicts a side cross-sectional view of the spindle assembly, in accordance with one or more embodiments of the present disclosure.

FIG. 2F illustrates a side view of a spindle with the anti-rotation device hidden, in accordance with one or more embodiments of the present disclosure.

FIG. 3A depicts a cross-sectional perspective view of a drive system illustrating the location of the anti-rotation device, in accordance with one or more embodiments of the present disclosure.

FIG. 3B depicts a perspective view of the drive system, in accordance with one or more embodiments of the present disclosure.

FIG. 3C depicts a cross-sectional view of the drive system, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to an anti-rotation device for steer-by wire vehicles. Steer-by wire vehicles present different design challenges, as no human input may be required. As a result, some components on traditional vehicles may become obsolete. This may be seen in the rack and pinion, as unnecessary aspects may be removed in order to reduce tooling and production costs. However, current designs rely on the rack and pinion for preventing rotation, even though this part may be unnecessary in steer-by wire vehicles. Therefore, it may be beneficial to remove the rack and pinion in order to reduce costs, in favor of introducing a new part to prevent rotation.

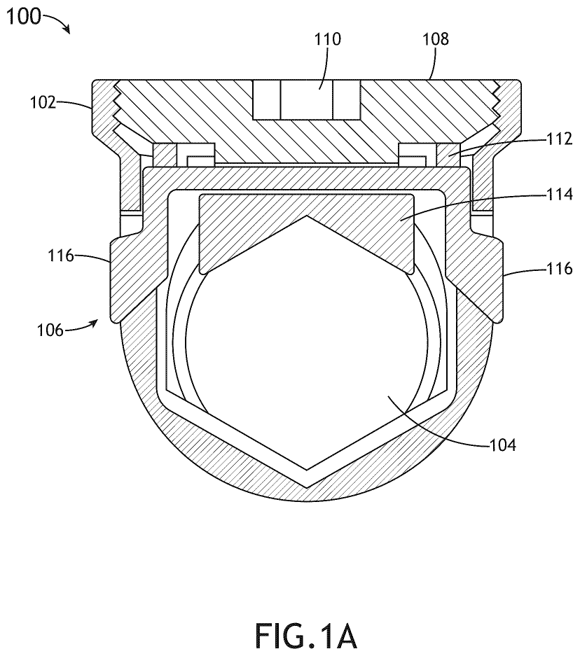

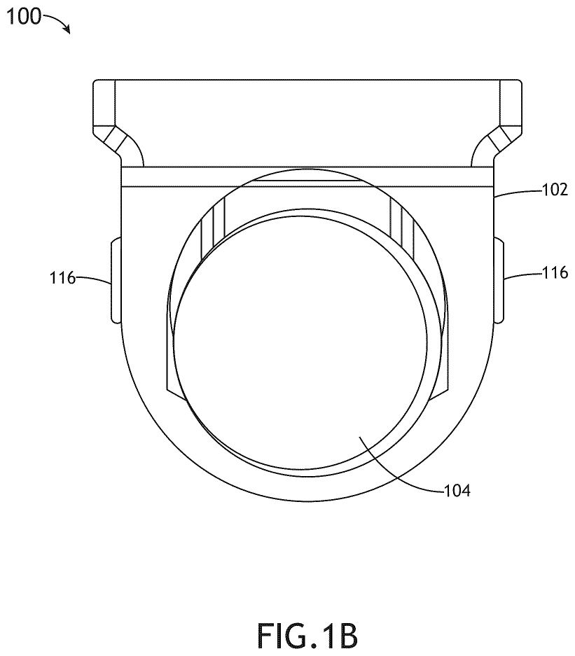

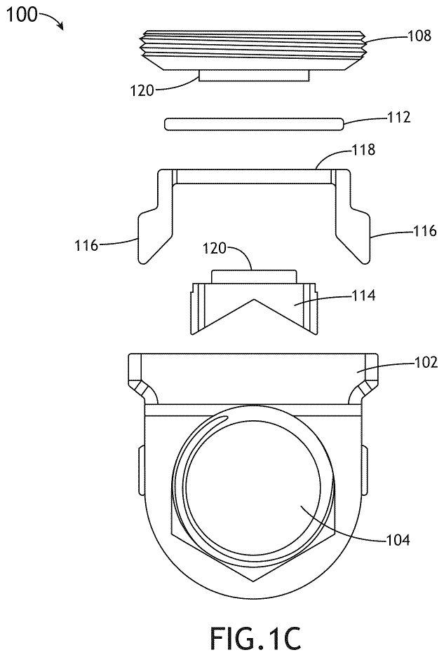

FIGS. 1A-1C depict an anti-rotation device 100, in accordance with one or more embodiments of the present disclosure.

In embodiments, the anti-rotation device 100 includes an outer housing 102. The outer housing 102 may define an interior cavity 104 and one or more exterior holes 106.

The interior cavity 104 may be of any shape and/or have multiple shapes make up its perimeter. For example, the interior cavity 104 may include a circular perimeter. By way of another example, an interior portion of the outer housing 102 (e.g., a portion of the outer housing 102 defining the interior cavity 104) may be threaded in order to accommodate a threaded spindle. By way of another example, a portion of the perimeter of the interior cavity 104 may be hexagonal. The interior cavity 104 may extend axially along the anti-rotation device 100.

The anti-rotation device 100 may include any number of exterior holes 106 located at any location of the outer housing 102. For example, the anti-rotation device 100 may include two exterior holes 106. The two exterior holes 106 may be located opposite each other. Additionally, the exterior holes 106 may be orthogonal to the interior cavity 104. For example, the exterior holes 106 may extend radially from the anti-rotation device 100. The exterior holes 106 may be through holes which may extend through the outer housing 102 to the interior cavity 104.

In embodiments, the anti-rotation device 100 includes a plunger 108. The plunger 108 may be coupled to the outer housing 102. For example, the plunger 108 may be coupled to the outer housing 102 with threads (e.g., the plunger 108 and the outer housing 102 may include matching threads). In this way, the position of the plunger 108 may be adjusted by rotating the plunger 108 clockwise or counterclockwise.

The plunger 108 may include one or more recesses 110 on its surface. The recesses 110 may be a blind-hole defined from an outer surface of the plunger 108. The recesses 110 may include a select shape. For example, the plunger 108 may include a cross-shaped recess 110, a linear recess 110, a hexagonal recess 110 or any other shape of recess 110 that may receive a tool (e.g., a drill bit). In this way, the recess 110 may facilitate coupling of the plunger 108 to the outer housing 102 by allowing for tools to move (e.g., rotate) the plunger 108.

In embodiments, the anti-rotation device 100 includes one or more springs 112. The springs 112 may be located under the plunger 108 and within the outer housing 102. The springs 112 may be in constant contact with the plunger 108. Further, the springs 112 may be configured to be compressed by the plunger 108. In this way, the springs 112 may be constantly compressed by the plunger 108. Additionally, the amount of compression on the springs 112 may be defined by stiffness of the springs 112 and/or design clearances after assembly of the anti-rotation device 100.

The springs 112 may be any springs 112 known in the art that are suitable for prolonged compression. For example, the springs 112 may be, but are not limited to, a compression spring, a wave springs, or a disk spring. Additionally, the springs 112 may be a rubber ring.

In embodiments, the anti-rotation device 100 includes a yoke 114. The yoke 114 may be located under the plunger 108 and be in contact with the plunger 108. The plunger 108 may be configured to compress the yoke 114 such that the yoke 114 is under a state of constant compression.

In embodiments, the anti-rotation device 100 includes one or more pads 116. The pads 116 may be coupled to each other by a rim 118. The pads 116 may be located under the springs 112 and may be in constant contact with the springs. The springs 112 may apply a force to the pads 116 (e.g., a force transferred to the pads 116 by the springs 112 due to the compression of the springs 112 by the plunger 108). The force applied to the pads 116 may cause the pads 116 to extend outwards through the exterior holes 106. The exterior holes 106 and the pads 116 may include opposing-slanted faces along which the pads 116 may ride along the exterior holes 106 as the pads 116 are forced downwards by the springs 112.

It is noted that the pads 116 may be configured to extend outwards in order to be in constant contact with a surface exterior to the anti-rotation device 100. In this way, the pads 116 may need to be constructed from a material that is designed to have a long life in high friction conditions. For example, the pads 116 may be made from a treated steel. By way of another example, the pads 116 may be made of nylon. By way of another example, the pads 116 may be made of a plastic, a reinforced plastic, or the like.

It is noted that within the anti-rotation device 100 certain aspects may be designed in order to prevent particular components from coming into contact with each other. For example, the anti-rotation device 100 may be designed such that the plunger 108 does not contact the pads 116. In this way, the springs 112 may be disposed in between the plunger 108 and the pads 116 and designed to prevent any contact between the plunger 108 and the pads 116. The prevention of contact between the plunger 108 and the pads 116 may be due to the rim 118 connecting the pads and the springs 112 having an equal diameter, such that the spring 112 will constantly cover the rim 118 and the pads 116 and prevent contact by the plunger 108.

It is noted that the springs 112 may not be necessary in the anti-rotation device 100. For example, the function of the springs 112 may be performed by the pads 116 and/or the rim 118 connecting the pads 116. In this way, the plunger 108 may contact the pads 116 and/or the rim 118 directly and cause the pads 116 to extend outwards through the exterior holes 106 of the outer housing 102. In embodiments where the pads 116 perform the function of the springs 112, compression may be defined by the stiffness of the pads 116.

The rim 118 may also be configured to facilitate contact between the plunger 108 and the yoke 114. For example, the rim 118 may be only about the perimeter of the outer housing 102 such that there is a hole in the middle. The hole in the middle of the rim 118 may allow the contact between the plunger 108 and the yoke 114.

It is further contemplated that the plunger 108 and/or the yoke 114 may include a protrusion 120 to form a pair of opposing protrusions 120. For example, the plunger 108 and the yoke 114 may include opposing protrusions 120, with one protrusion on the plunger 108 and another protrusion on the yoke 114. The protrusions 120 may facilitate contact between the plunger 108 and the yoke 114 by allowing a part of the plunger 108 and/or the yoke 114 to pass through the rim 118, where the full plunger 108 and/or yoke 114 would not be able to pass through the rim 118 without contacting the pads 116.

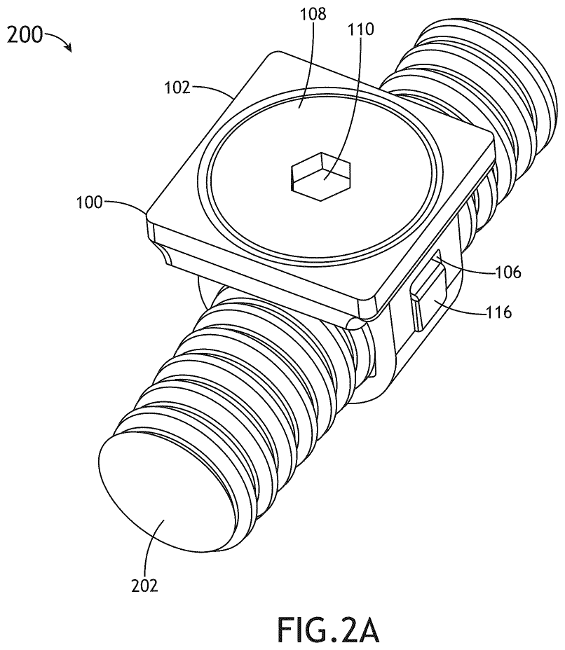

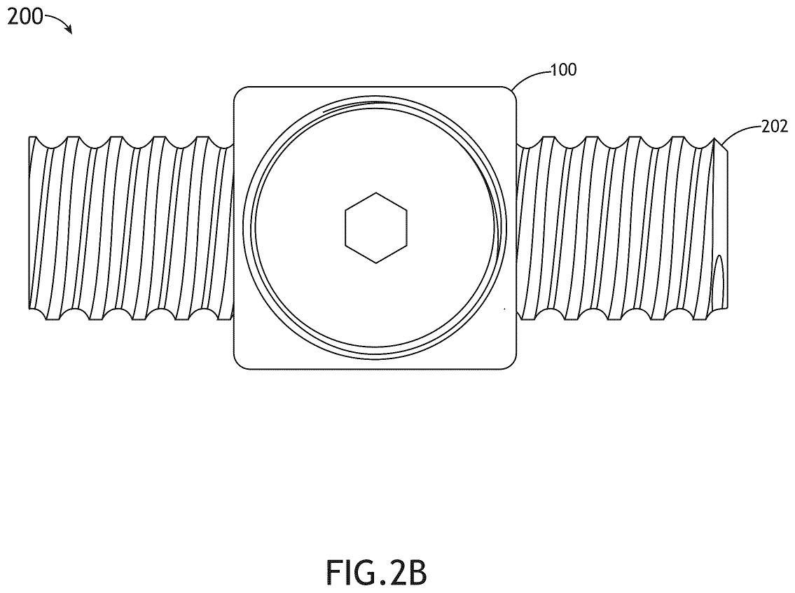

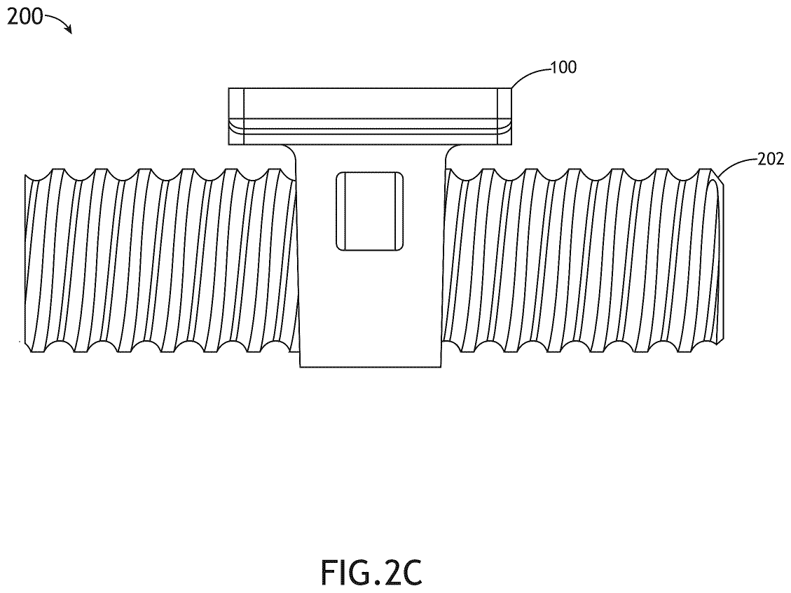

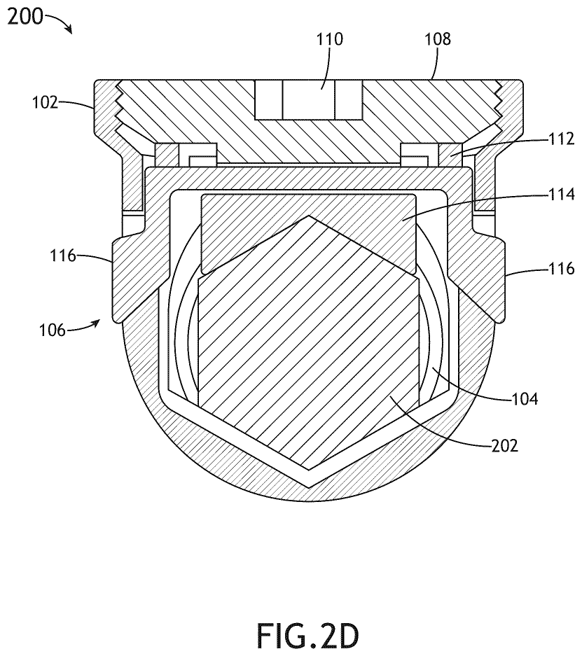

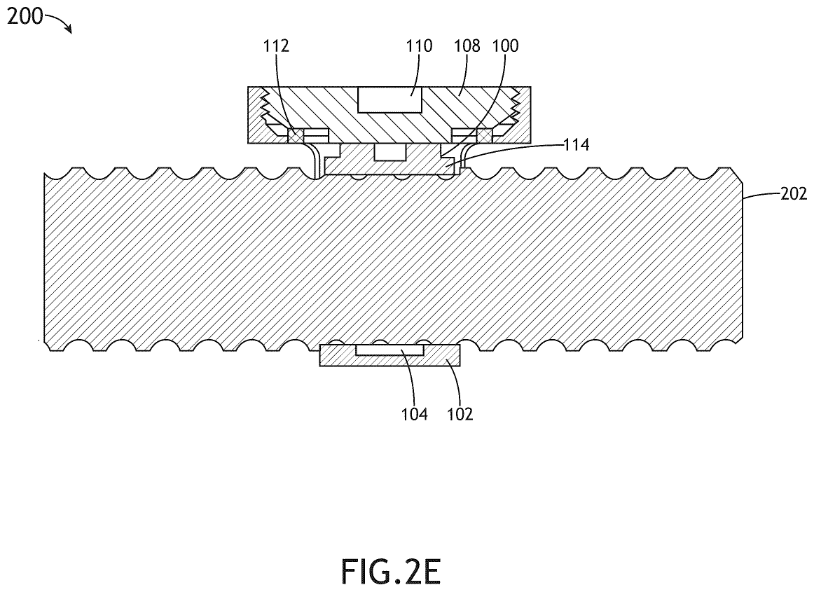

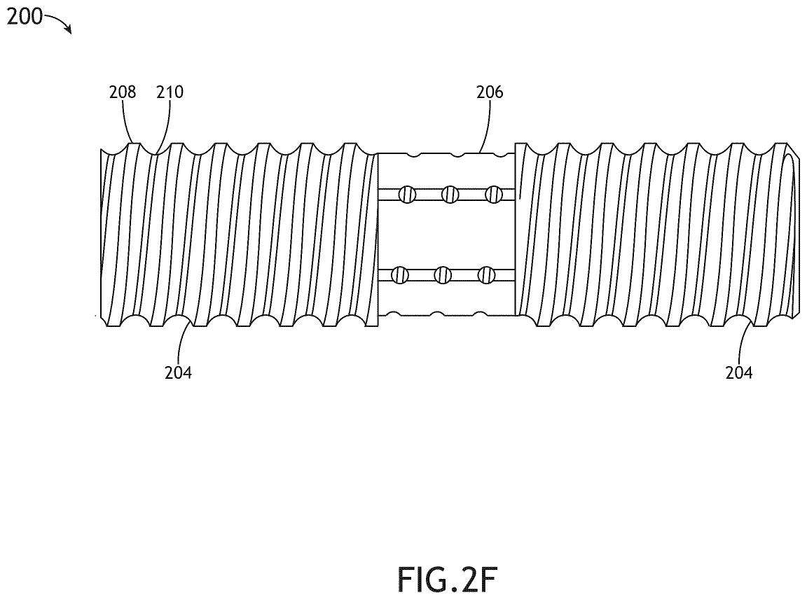

FIGS. 2A-2F depict a spindle assembly 200, in accordance with one or more embodiments of the present disclosure. The spindle assembly 200 may include a spindle 202 and the anti-rotation device 100.

The spindle 202 may be any body including a rotating axis. The spindle 202 may be coupled to any other body. The spindle 202 may further be configured to transfer energy (e.g., rotational energy) to other bodies.

The spindle 202 may include one or more threaded areas 204 and one or more coupling areas 206. The threaded areas 204 may include a major diameter 208 (e.g., the largest diameter of the spindle 202) and a minor diameter 210 (e.g., the smallest diameter of the threaded areas 204 of the spindle). Further, it is noted that the minor diameter 210 may be larger, smaller, or the same size as the diameter of the coupling area 206. The coupling area 206 may be located between two threaded areas 204. Additionally, the coupling area 206 may be located at an end of the spindle 202.

The outer housing 102 may surround at least a portion of the coupling area 206 of the spindle 202. For example, the interior cavity 104 of the outer housing 102 may surround the coupling area 206. In this way, the interior cavity 104 may be larger than the major diameter 208 of the spindle (e.g., in order to allow spindle 202 to slide through the anti-rotation device 100 in order to install the anti-rotation device 100).

The anti-rotation device 100 may be configured to secure the spindle 202 within the interior cavity 104 of the outer housing 102. For example, the compression of the yoke 114 by the plunger 108 may cause the yoke 114 to contact the spindle 202. The force applied by the yoke 114 to the spindle 202 may further cause the spindle 202 to come into contact with the outer housing 102 opposite the yoke 114.

The outer housing 102 and the yoke 114 may be configured to have a shape to match a contour of the coupling area 206 of the spindle 202. In this way, the yoke 114 and the outer housing 102 may secure the spindle 202 when the plunger 108 causes contact between the yoke 114, the outer housing 102, and the spindle 202.

It is noted that the coupling area 206 of the spindle 202 may be configured so it has any contour that would result in a secure connection when in contact with the yoke 114 and the outer housing 102. For example, the contour of the coupling area 206 of the spindle 202 may be a hexagon-shaped contour. The outer housing 102 and the yoke 114 may define triangular shapes which may match the contour of a top and bottom vertices and associated faces of the hexagon-shaped contour.

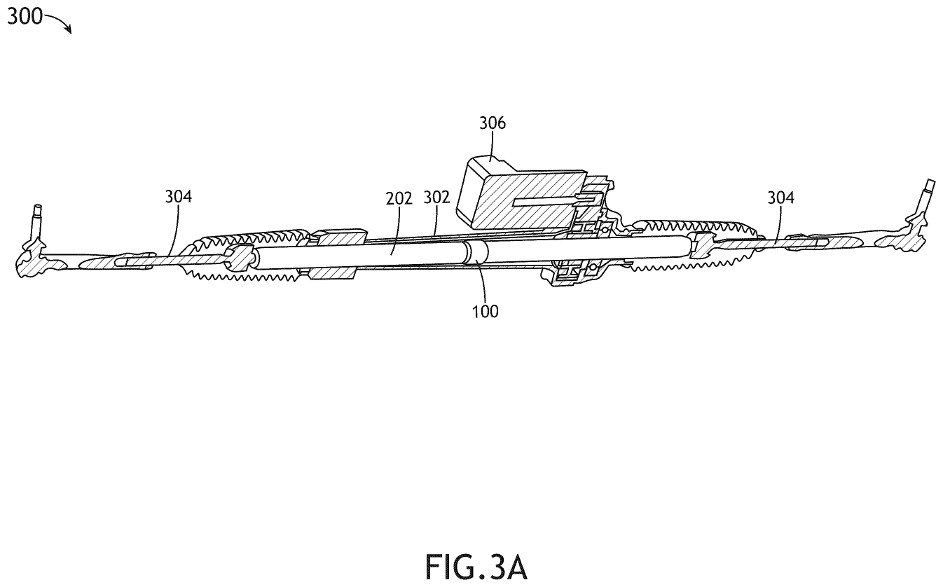

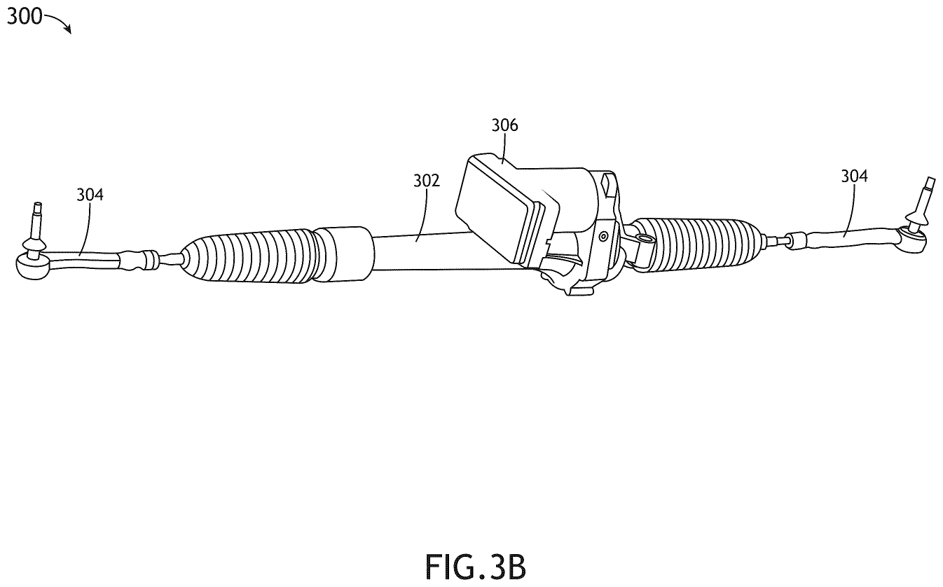

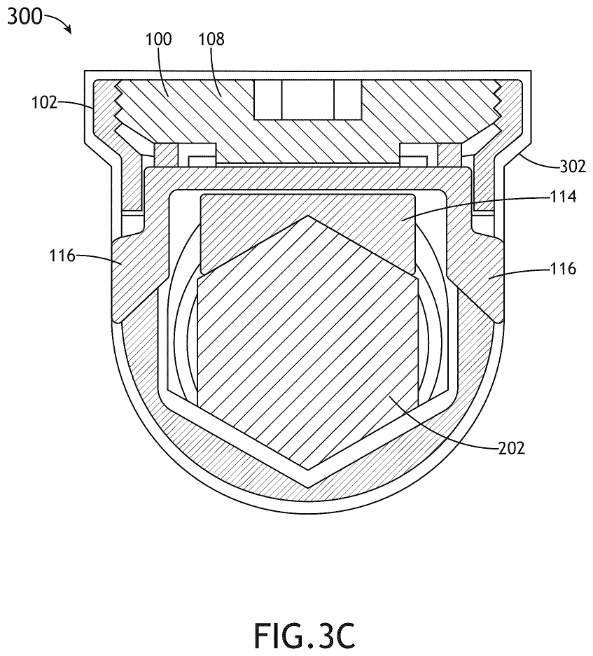

FIGS. 3A-3C illustrate a drive system 300, in accordance with one or more embodiments of the present disclosure.

In embodiments, the drive system 300 includes a housing 302. The housing 302 may be designed to surround the anti-rotation device 100 and the spindle 202 (e.g., the spindle assembly 200).

When the pads 116 extend out of the outer housing 102 through the exterior holes 106, the pads may come into contact with the housing 302. As a result, the pads 116 may hold the anti-rotation device 100 and the spindle 202 preventing rotation relative to the housing 302. This may prevent any unwanted rotation within the housing 302 and/or the drive system 300 as a whole. In this way, a prismatic joint may be formed with the housing 302, such that motion is restricted along all but one axis. The anti-rotation device 100 may prevent rotation of the spindle 202 relative to the housing 302 as the spindle 202 and the anti-rotation device 100 translates axially together relative to the housing 302.

In embodiments, the drive system 300 includes one or more rods 304. The rods 304 may also be referred to as tie-rods, rod-ends, or the like. The rods 304 may be connected to the spindle 202. The rods 304 may be connected between the spindle 202 and a steering arm or knuckle of a vehicle. The axial translation of the spindle 202 may cause axial translation of the rods 304. The spindle 202 may also be connected to an electric motor 306. For example, the threaded areas 204 of the spindle 202 may be connected to the electric motor 306. The electric motor 306 may cause the spindle 202 to axially translate relative to the housing 302. The rods 304 may be connected to the electric motor 306 via the spindle 202 (e.g., in order to transfer energy). The electric motor 306 may be a power-steering actuator of the drive system 300.

The electric motor 306 may be associated with an autonomous vehicle, a steer-by-wire vehicle, or any steering system where anti-rotation is needed.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 anti-rotation device
102 outer housing
104 interior cavity
106 exterior holes
108 plunger
110 recess
112 springs
114 yoke
116 pads
118 rim
120 protrusion
200 spindle assembly
202 spindle
204 threaded area
206 coupling area
208 major diameter
210 minor diameter
300 drive system
302 housing
304 rods
306 electric motor

What is claimed:

1. An anti-rotation device comprising:
an outer housing defining an interior cavity and one or more exterior holes;
a plunger coupled to the outer housing;
a yoke in contact with the plunger and configured to be compressed by the plunger; and
one or more pads configured to extend outwards through the one or more exterior holes of the outer housing due to the compression of the plunger.

2. The anti-rotation device of claim 1, wherein the plunger is coupled to the outer housing by threads on the plunger and the outer housing.

3. The anti-rotation device of claim 1, wherein the one or more pads are made of treated steel.

4. The anti-rotation device of claim 1, wherein the one or more pads are made of one of nylon, plastic, or reinforced plastic.

5. The anti-rotation device of claim 1, wherein the one or more pads are coupled to each other by a rim.

6. The anti-rotation device of claim 5, wherein the rim coupling the one or more pads is configured to allow contact between the plunger and the yoke.

7. The anti-rotation device of claim 6, wherein the plunger and the yoke contact each other through the rim by a pair of opposing protrusions, with one protrusion located on the plunger and another protrusion located on the yoke.

8. The anti-rotation device of claim 5, further comprising one or more springs disposed between the plunger and the one or more pads, wherein the one or more springs are in contact with the plunger, wherein the one or more springs are configured to be compressed by the plunger to cause the one or more pads to extend outwards.

9. The anti-rotation device of claim 8, wherein the one or more springs are configured as one of: a rubber ring, a compression spring, a wave spring, or a disk spring.

10. The anti-rotation device of claim 8, wherein the rim and the one or more springs have an equal diameter.

11. The anti-rotation device of claim 1, wherein the one or more exterior holes defined by the outer housing includes two exterior holes located opposite each other.

12. The anti-rotation device of claim 1, wherein the plunger includes one or more recesses to facilitate coupling with the outer housing.

13. A spindle assembly comprising:
a spindle; and
an anti-rotation device comprising:
an outer housing defining an interior cavity larger than a major diameter of the spindle and one or more exterior holes and configured to surround at least a coupling area of the spindle;
a plunger coupled to the outer housing;
a yoke in contact with the plunger and configured to be compressed by the plunger in order to make contact with the spindle and further cause the spindle to contact the outer housing opposite the yoke; and
one or more pads configured to extend outwards through the one or more exterior holes of the outer housing due to the compression of the plunger.

14. The spindle assembly of claim 13, wherein the interior cavity of the outer housing has a shape configured to match a contour of the coupling area of the spindle.

15. The spindle assembly of claim 13, wherein the yoke has a shape configured to match a contour of the coupling area of the spindle.

16. The spindle assembly of claim 13, wherein the coupling area of the spindle surrounded has a hexagon-shaped contour.

17. The spindle assembly of claim 13, wherein the coupling area of the spindle is located between threaded areas of the spindle.

18. A drive system comprising:
a spindle;
a housing;
one or more rods; and
an anti-rotation device comprising:
an outer housing defining an interior cavity larger than a major diameter of the spindle and an interior cavity and one or more exterior holes and configured to surround at least a coupling area of the spindle;
a plunger coupled to the outer housing;
a yoke in contact with the plunger and configured to be compressed by the plunger in order to make contact with the spindle and further cause the spindle to contact the outer housing opposite the yoke; and
one or more pads configured to extend outwards through the one or more exterior holes of the outer housing due to the compression of the plunger and apply a force on the housing in order to prevent rotation of the spindle relative to the housing.

19. The drive system of claim 18, wherein the anti-rotation device forms a prismatic joint with the housing.

20. The drive system of claim 18, comprising an electric motor, wherein the spindle is connected to the electric motor.
